(19) United States
(12) Patent Application Publication
(10) Pub. No.: US 2023/0084573 A1
(43) Pub. Date: Mar. 16, 2023

(54) RELIABILITY REFERENCE MODEL FOR TOPOLOGY CONFIGURATION

(71) Applicant: AT&T Intellectual Property I, L.P., Atlanta, GA (US)

(72) Inventor: Paul Reeser, Red Bank, NJ (US)

(73) Assignee: AT&T Intellectual Property I, L.P., Atlanta, GA (US)

(21) Appl. No.: 17/465,150

(22) Filed: Sep. 2, 2021

(51) Int. Cl. G06N 7/00; G06F 17/18; H04L 12/24

(52) U.S. Cl. CPC G06N 7/005; G06F 17/18; H04L 41/0654; H04L 41/5012

(57) ABSTRACT

A topology configuration tool for optimizing resources to meet requirements. The tool may use a derivation of the composite service outage and restoral rates as a function of the number of servers, the number of sites, and the minimum required server capacity level, using an adaptation of the hyper-geometric “balls in urns” distribution with unequally likely combinations.

### BACKGROUND

The mean time between failures (MTBF) is the average time between component software or equipment failures that result in partial loss of system capacity.

The mean time between outages (MTBO) is the average time between component failures that result in loss of system continuity or unacceptable capacity, performance, or reliability degradation.

This background information is provided to reveal information believed by the applicant to be of possible relevance. No admission is necessarily intended, nor should be construed, that any of the preceding information constitutes prior art.

### SUMMARY

The disclosed subject matter illustrates an approach to topology configuration and optimization, which may address geo-redundancy issues, such as how many sites, and how many servers per site, are required to meet performance and reliability requirements. The disclosed multi-dimensional component failure mode reference model may be reduced to a one-dimensional service outage mode reference model. In the topology configuration approach, a novel adaptation of the hyper-geometric “balls in urns” distribution with unequally likely combinations may be used.

In an example, an apparatus may include a processor and a memory coupled with the processor that effectuates operations. The operations may include receiving a number of geographically diverse sites for a service; receiving a minimum availability of the service; based on the number of geographically diverse sites and the minimum availability, determining a probability that the service is up (Pup), mean time between service outages (F), and mean restoral time (R); and sending an alert that includes the PUP, F, and R.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates state transition diagram for the small reference model of N=6, M=2, and K=3.

FIG. 2 illustrates different models for collapsing failure modes while maintaining integrity of the mean restoral time.

FIG. 3 illustrates collapsing failure levels for the small reference model of N=6, M=2, and K=3.

FIG. 4 illustrates feasible transitions from an ‘up’ state to a ‘down’ state.

FIG. 5 illustrates feasible combinations for the small reference model of N=6, M=2, K=3.

FIG. 6 illustrates relationship between allowable processing time and required number of vCPUs.

FIG. 7 illustrates an exemplary method for reliability reference model for topology configuration.

FIG. 8 illustrates a schematic of an exemplary network device.

FIG. 9 illustrates an exemplary communication system that provides wireless telecommunication services over wireless communication networks.

### DETAILED DESCRIPTION

Most availability analyses typically start by characterizing a failure mode reference model that captures the underlying hardware (HW) and software (SW) components that constitute an application deployment. From a performance:reliability:cost optimization perspective, these models are typically used to determine the minimal topology required to meet the distributed application capacity and availability requirements.

Herein, a simple 2-tiered reference model is used that includes servers and sites to illustrate an approach to topology configuration, with consideration of common geo-redundancy questions like how many sites, and how many servers per site, are required to meet a set of capacity, performance, and reliability requirements. Even for this simple 2-tiered reference model, the number of states grows exponentially. The techniques demonstrate how to reduce the state space of more complex models and how to collapse a state transition diagram into a one-dimensional representation in terms of the amount of available server capacity, where transitions can occur across multiple levels.

At the service level, application outages may matter more than individual failures. Thus, a generic outage mode reference model may be created based on the one-dimensional representation of the failure model. The exact derivation of the outage and restoral rates from the superset of ‘available’ states to the superset of ‘unavailable’ states as a function of the number of servers, the number of sites, and the minimum required server capacity level is disclosed.

Although there have been several attempts to analyze and optimize the availability of redundant, distributed topologies, especially in the context of storage systems and virtualized applications, conventional methods have not derived the exact general formula for the composite service outage and restoral rates, based on the hyper-geometric distribution with unequally likely combinations.

### Reference Failure Model

### Notation and Input Parameters

Typical availability analyses start by characterizing a failure mode reference model that captures the underlying HW elements and SW components that constitute the application deployment. These failure models can vary widely in their level of detail, from simple block diagrams to sophisticated failure trees. In most practical cases this detail can be aggregated to reduce the model complexity to a one-dimensional state space without losing the underlying individual component failure and restoral rates, dependencies, or interactions.

Typical reliability optimization questions that these models need to address include the “how many eggs in one basket” type: How many application processes can run on a single host? How many host servers in one rack? How many racks in one datacenter site? How many sites per region? For the analysis to follow, there may be an assumption of simple 2-tiered reference model including servers and sites, and a focus herein is the common geo-redundancy questions: how many sites and how many servers per site? Generalization to more than two tiers is contemplated.

Let M denote the number of geographically diverse sites (e.g., datacenters) and let N denote the number of hosts (servers). For simplicity, assume that Nis an integer multiple of M, and that N identical hosts are spread evenly across M identical sites. Let J=N/M denote the number of hosts per site. Hosts and sites are the HW elements.

For the purposes of this analysis, geographic diversity of sites means that there is no single point of failure that can cause the failure of multiple sites simultaneously. As examples, sites are not geographically diverse if they are located in the same physical building, or share a common HVAC cooling system, or share the same commercial power source at any point along the distribution including point of generation, or share the same transmission links at any point along the data path, etc. Other factors that could be considered include shared natural disaster zones (earthquake fault lines, wildfire regions, storm and flood zones, etc.).

A single identical application instance may be running on each host, and the set of J instances at each site make up the resident application function. Instances and resident functions are the SW elements. Assume that hosts and their associated instances are tightly coupled (that is, if a host is down its associated instance is unavailable, and vice versa). Similarly, assume that sites and their resident function (set of J instances) are tightly coupled (that is, if a site is down its resident function is unavailable, and vice versa). Let K denote the minimum number of instances required for service to be up (e.g., to have adequate capacity to serve the workload with acceptable performance and reliability).

Next, let {λ_{I}⁻¹, λ_{F}⁻¹, λ_{H}⁻¹, λ_{S}⁻¹} denote the mean time between failure (MTBF) and let {μ_{I}⁻¹, α_{F}⁻¹, μ_{H}⁻¹, μ_{S}⁻¹} denote the mean time to restore (MTTR) of the {Instance SW, Function SW, Host HW, and Site HW}, respectively. Then the typical failure modes and associated effects (e.g., capacity impacts) for this canonical reference model are given in Table 1. Also, table 1 includes default values for the MTBFs and MTTRs in brackets [ ] that will be used for the simple example as described in more detail herein.

A typical SW fault impacting a single instance may be a memory leak or buffer overflow that leads to an application restart. A typical (less frequent) fault impacting an entire resident function may be the corruption of shared local data, or a latent bug in a code branch that, once triggered by one instance, cascades to the other instances when the transaction retries to execute the same code segment. A typical HW failure impacting a single host may be a fan failure, while a typical failure impacting an entire site may be a transfer switch failure following a commercial power outage.

TABLE 1
Simple failure mode reference model.

| | | | | | | Capacity |
|---|---|---|---|---|---|---|
| Failure Mode | Count | MTBF λ⁻¹ | | MTTR μ⁻¹ | | Impact |
| Single SW | N | λ_{I}⁻¹ | [3 mo] | μ_{I}⁻¹ | [1 hr] | 1 instance |
| instance | | | | | | |
| Resident SW | M | λ_{F}⁻¹ | [2 yr] | μ_{F}⁻¹ | [6 hr] | Up to J |
| function | | | | | | instances |
| Single HW host | N | λ_{H}⁻¹ | [6 mo] | μ_{H}⁻¹ | [2 hr] | 1 instance |
| Entire HW site | M | λ_{S}⁻¹ | [2 yr] | μ_{S}⁻¹ | [4 hr] | Up to J |
| | | | | | | instances |

### Probability State Space

Subsequent to the failure mode reference model development, a state space transition diagram may be developed and the transition probabilities solved for. In order to make the analysis tractable, the failure and restoral rates are assumed to be exponentially distributed, and the associated stochastic process is assumed to form a Markov chain (MC). A first step in this approach is to characterize states in terms of the amount of available capacity. To illustrate for this simple reference model, let the M-tuple (j₁, . . . , jₘ, . . . , j_{M}) denote the number of instances up at each site m=1, . . . , M, where 0≤jₘ≤J. There are (J+1)^{M} total states. A ‘level’ in the state diagram may include all states with n total instances up, where Σₘ₌₁^{M}(jₘ)=n for every state on level n (0≤n≤N). For all levels where n≥K, the service is up; otherwise, service is down.

Next, the state transitions may be specified. In this simple reference model, events can result in 1-level transitions in the case of host/instance failure and restoral, or up to J-level transitions in the case of site/function failure and restoral. Finally, enumerate and solve the resulting balance equations to determine the state probabilities. Unfortunately, the state diagram becomes unwieldy very quickly as N and M grow, and the balance equations become virtually impossible to solve by hand to get the explicit equations for the state probabilities. Commercial packages and statistical languages, such as MATLAB provide efficient and stable algorithms for finding the eigenvalues of a matrix, and many optimized library routines such as Eigen and Armadillo have been written to embed the code directly in various languages.

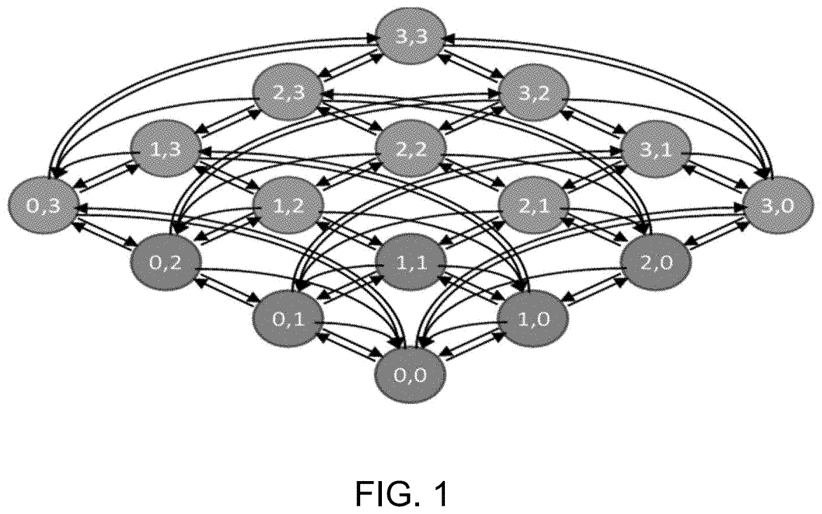

FIG. 1 shows the state space and feasible transitions for the small reference model of N=6, M=2, and K=3. Service is available for green states and unavailable for red states. Straight transition arrows correspond to single host/instance failure and restoral, while curved transition arrows correspond to site/function failure and restoral.

As a prelude to the outage mode reference model presented later, looking closely, a service outage can occur from any state other than the level 6 ‘all up’ state (3,3). In general, an outage can occur from any level n state where n−J<K. The exact derivation of the composite outage and restoral rates between the superset of available (‘up’) states and the superset of unavailable (‘down’) states as function of the input parameters N, M, and K, may be based on an adaptation of the hyper-geometric “balls in urns” distribution with unequally likely combinations. Knowing these rates is critical when sizing deployments for services with stringent (e.g., FCC reportable) outage and restoral requirements.

### Collapsing Failure Modes

The second step in advancing the state space modeling is collapsing the failure modes; that is, combining all (HW and SW) failure and restoral rates causing single instance as well as single site transitions. To this end, let {A_{I}, A_{F}, A_{H}, A_{S}} denote the availability

$$( A = \frac{μ}{λ + μ} )$$

and let {ρ_{I}, ρ_{F}, ρ_{H}, ρ_{S}} denote the utilization (ρ=λ/μ) of the {instance SW, function SW, host HW, and site HW}, respectively. First, combine the failure rates, loads, and availabilities. Let

λ_{N}≡host(HW+SW) failure rate=λ_{I}+λ_{H}

λ_{M}≡site(HW+SW) failure rate=λ_{F}+λ_{S} (1)

ρ_{N}≡host(HW+SW) failure load=ρ_{I}+ρ_{H}

ρ_{M}≡site(HW+SW) failure load=ρ_{F}+ρ_{S} (2)

A_{N}≡host(HW+SW) availability=A_{I}A_{H}

A_{M}≡site(HW+SW) availability=A_{F}A_{S} (3)

Now considering composite restoral rates, let

μ_{N}≡host(HW+SW) restoral rate

μ_{M}≡site(HW+SW) restoral rate (4)

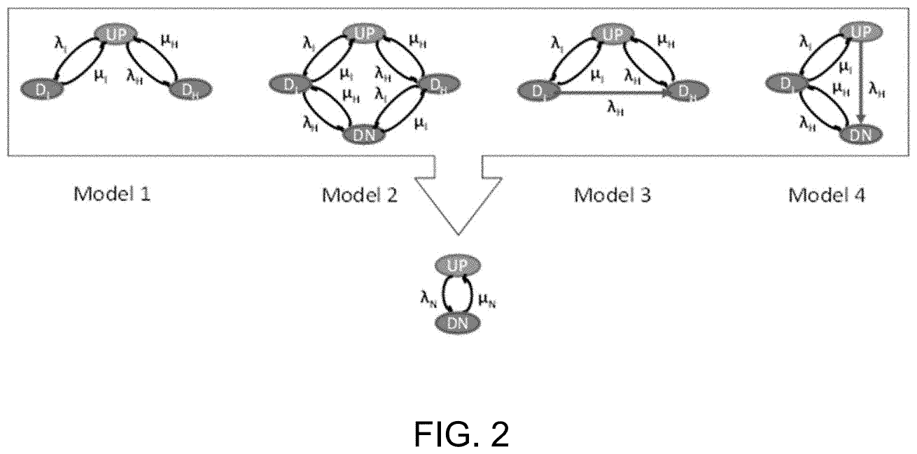

The mathematical approach to collapsing restoral rates depends on the particular failure mode interactions and dependencies. FIG. 2 shows four different models, all leading to different values for μ_{N} and μ_{M}. First, Model 1 is most appropriate if all failure activity stops when any failure occurs. In this case, it can be shown that

Model 1: μ_{N}=λ_{N}/ρ_{N}=λ_{N}/(ρ_{H}+ρ_{I})

μ_{M}=λ_{M}/ρ_{M}=λ_{M}/(ρ_{S}+ρ_{F}). (5)

Next, Model 2 is most appropriate if all failure activity stops when all failures occur. In this case, it can be shown that

Model 2: μ_{N}=λ_{N}/(ρ_{N}+ρ_{I}ρ_{H})=λ_{N}/(ρ_{H}+(1+ρ_{H})ρ_{I})

μ_{M}=λ_{M}/(ρ_{M}+ρ_{F}ρ_{S})=λ_{M}/(ρ_{S}+(1+ρ_{S})ρ_{F}). (6)

Model 3 is most appropriate if all failure activity stops when a select failure occurs (host failure for μ_{N} or site failure μ_{M}). In this case, it can be shown that

$$Model 3$$

$${μ}_{N} = {λ}_{N} / ( {ρ}_{H} + ( 1 + {ρ}_{H} ) \frac{{λ}_{I}}{{λ}_{H} + {μ}_{F}} ) \\ {μ}_{M} = {λ}_{M} / ( {ρ}_{S} + ( 1 + {ρ}_{S} ) \frac{{λ}_{F}}{{λ}_{S} + {μ}_{F}} ) . \qquad ( 7 )$$

Finally, Model 4 is most appropriate if all failure activity stops when a select failure occurs, and restoral activity is sequential (e.g., host then instance for μ_{N} or site then resident function μ_{M}). In this case, it can be shown that

$$Model 4$$

$${μ}_{N} = {λ}_{N} / ( {ρ}_{H} + ( 1 + {ρ}_{H} ) \frac{{λ}_{N}}{{μ}_{F}} ) \\ {μ}_{M} = {λ}_{M} / ( {ρ}_{S} + ( 1 + {ρ}_{S} ) \frac{{λ}_{M}}{{μ}_{S}} ) . \qquad ( 8 )$$

Each model is suitable for different reliability scenarios. The simplicity of Model 1, for instance, makes it a good choice when combining many failure modes (e.g., internal components of a server). Model 2 works well if all element failures and replacements are independent (e.g., PC peripheral devices). Model 3 and Model 4 are most suitable if failure modes are hierarchical (e.g., user session controlled by application SW running on server HW). Model 4 is most appropriate for our reference failure model, since the instance (or function) sits on top of the underlying host (or site) HW, and recovery involves replacing the HW and restarting the SW in sequence.

While these example state space aggregation models are exact in terms of the mean restoral rate, the resulting model may no longer form a MC. For tractability of analysis, the aggregate restoral rates are still assumed to be exponentially distributed, and the resulting collapsed model is still assumed to form a MC.

Additional complexities can be incorporated without complicating the analysis. For example, an important implication of network function virtualization (NFV) is the increased importance and added difficulty of fault detection and test coverage. Separating SW from HW (with possibly different vendors for each) creates additional reliability requirements enforcement challenges, such as how to ensure that different vendors have robust defect instrumentation and detection mechanisms if failures lie within the interaction between SW and HW, and how to ensure that test coverage is adequate. From an analysis standpoint, detection and coverage may be included. Let Cₓ denote the coverage factors and let vₓ⁻¹ denote the uncovered MTTRs (including detection time) for x∈{I, F, H, S}. Then replace μₓ by μₓ′=Cₓμₓ+(1−Cₓ)vₓ.

As another example, consider scheduled maintenance. Single instance or host maintenance may be rolling application or firmware upgrades. Resident function or site maintenance may be shared database upgrades or power backup testing. Let δₓ denote the maintenance rates, let γₓ⁻¹ denote the maintenance MTTRs, and let πₓ=δₓ/γₓ denote the maintenance load for x∈{I, F, H, S}. Then we can replace λₓ by λₓ′=λₓ+δₓ, ρₓ by ρₓ′=ρₓ+πₓ, and μₓ by μₓ′=λₓ′/ρₓ′.

### Collapsing Failure Levels

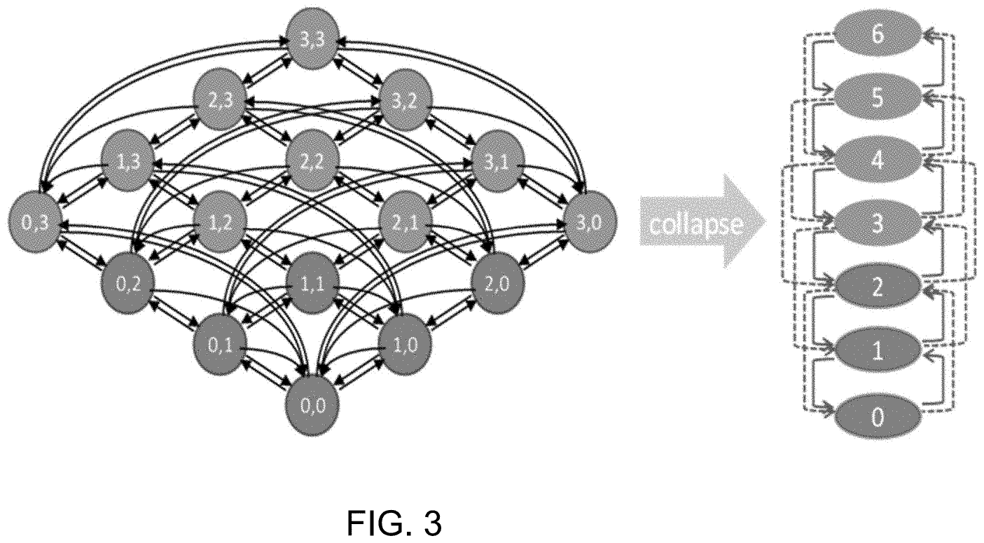

The next step in refining our state space representation is to collapse the failure levels by combining all states with the same number of available instances (capacity levels) and consolidating capacity level transition rates. FIG. 3 illustrates the approach for small reference failure model of N=6, M=2, and K=3. As can be seen, state space is reduced to N+1 states, and individual transitions are consolidated. All transitions due to failure/restoral of a single instance/host result in single-level transitions ( [symbol] ). Some single- and all multi-level transitions (---) are due to failure/restoral of an entire resident function/site. For this analysis, the aggregate transition rates are again assumed to be exponentially distributed, and the resulting collapsed model is still assumed to form a MC.

As stated, there may be an exact derivation of these composite transition rates, and in particular, the outage rate from the superset of ‘up’ states to the superset of ‘down’ states as a function of N, M, and K.

### Reference Outage Model

### Notation and Formulation

At the service level, application outages usually matter more than individual failures, therefore the need of a generic outage mode reference model (based on the failure modes). To this end, let n∈[0, N] denote the number of instances up, and let m∈[0, M] denote the number of sites up. Next, let Pₙ denote the probability that n instances are up (0≤n≤N), let P_{UP} denote the probability that ≥K instances are up (e.g., adequate capacity), and let P_{DN}=1−P_{UP} denote the probability that <K instances are up (e.g., service outage). Finally, let F≡λ_{D}⁻¹ denote the mean time between service outages and let R≡μ_{U}⁻¹ denote the mean time to restore service following an outage.

Then the capacity level state probabilities Pₙ are given by

$${P}_{n} = {\sum }_{m = [ n / J ]}^{M} ( \begin{matrix}M \\ m\end{matrix} ) {{A}_{M}^{m} ( 1 - {A}_{M} )}^{M - m} ( \begin{matrix}mJ \\ n\end{matrix} ) {{A}_{N}^{n} ( 1 - {A}_{N} )}^{mJ - n} , \qquad ( 9 )$$

where ┌x┐ in (9) denotes the smallest integer≥x.

The probability that the service is up P_{UP} and the ratio F/R are given by

$${P}_{UP} = {\sum }_{n = K}^{N} {P}_{n} and \frac{F}{R} = \frac{{μ}_{U}}{{λ}_{D}} = \frac{{P}_{UP}}{1 - {P}_{UP}} . \qquad ( 10 )$$

In preparation for the analysis to follow, decompose Pₙ as

$${P}_{n} = {\sum }_{m = ⌈ n / J ⌉}^{M} {P}_{n \vert m} {P}_{M} ( m ) , \\ where {P}_{n \vert m} = ( \begin{matrix}mJ \\ n\end{matrix} ) {{A}_{N}^{n} ( 1 - {A}_{N} )}^{mJ - n} and \\ {P}_{M} ( m ) = ( \begin{matrix}M \\ m\end{matrix} ) {{A}_{M}^{m} ( 1 - {A}_{M} )}^{M - m} . \qquad ( 11 )$$

### Balls in Urns Formulation

Note that

$$\frac{F}{R} = \frac{{μ}_{U}}{{λ}_{D}}$$

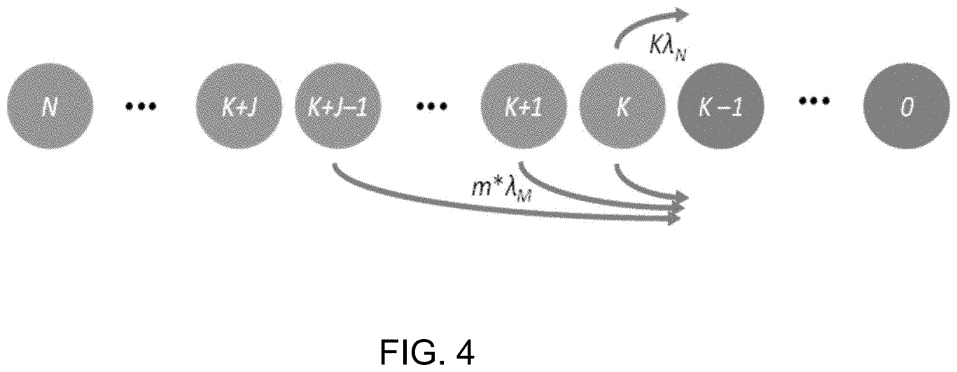

is expressed as a ratio in (10), thus what remains is to determine λ_{D} (the transition rate from the ‘up’ super-state to the ‘down’ super-state). FIG. 4 shows the relevant transitions from an ‘up’ state to a ‘down’ state. For K+J≤n≤N, transitions from n to the ‘down’ super-state (DN) are not possible. For K+1≤n≤K−1+J, transitions from n→DN can occur if 1 of m sites fails. And for n=K, transitions from K→DN can occur if 1 of m sites fails and do occur if 1 of K instances fails. Let m*(n) denote the number of sites with at least enough (n−K+1) instances up, such that its failure leaves <K instances up. We now need to determine m* for each applicable n.

Mathematical structure around the solution is provided below. λ_{D} is given by

$${λ}_{D} = {\sum }_{n = K}^{m i n ( K - 1 + J , N )} [ {\sum }_{m = ⌈ n / J ⌉}^{M} {P}_{n \vert m} [ {m}^{*} ( n ) ] {P}_{M} ( m ) ] {λ}_{M} + {P}_{K} K {λ}_{N} , \qquad ( 12 )$$

where m*(n) in (12) is the number of sites out of m with >n−K instances up. The quantities P_{n|m}[m*(n)]P_{M}(m) inside the inner sum are the (weighted) combinations of ways to distribute n instances to m sites. The inner sum is across all sites m that could be up

$$( m \geq ⌈ \frac{n}{J} ⌉ ) ,$$

and the outer sum is across all states n where transition from n to DN due to site failure is possible.

The solution is a specialized “balls in urns” problem involving the hyper-geometric distribution. There are N balls (instances) distributed in M urns (sites) with exactly J balls in each urn. Of the population of N balls, n are UP balls and N−n are DN balls. For M=2, there are

$$( \begin{matrix}n \\ i\end{matrix} ) ( \begin{matrix}N - n \\ J - i\end{matrix} ) / ( \begin{matrix}N \\ J\end{matrix} ) = ( \begin{matrix}J \\ i\end{matrix} ) ( \begin{matrix}J \\ n - i\end{matrix} ) / ( \begin{matrix}N \\ n\end{matrix} )$$

ways of distributing J instances into site 1 such that i instances are UP and J−i instances are DN (with the remaining instances in site 2). For M=3, there are

$$( \begin{matrix}J \\ i\end{matrix} ) ( \begin{matrix}J \\ j\end{matrix} ) ( \begin{matrix}J \\ n - i - j\end{matrix} ) / ( \begin{matrix}N \\ n\end{matrix} )$$

ways of distributing i UP instances into site 1, j UP instances into site 2, and n−i−j UP instances into site 3. For general M, there are

$$( \begin{matrix}J \\ i\end{matrix} ) ( \begin{matrix}J \\ j\end{matrix} ) … ( \begin{matrix}J \\ z\end{matrix} ) ( \begin{matrix}J \\ n - i - j - … - z\end{matrix} ) / ( \begin{matrix}N \\ n\end{matrix} )$$

ways of distributing n UP instances into M sites.

For simplicity, consider the case of M=2 sites. It would seem that

$${λ}_{D} = {\sum }_{n = K}^{m i n ( K - 1 + J , N )} {P}_{n} [ {\sum }_{i = m a x ( 0 , n - J )}^{m i n ( n , J )} \frac{( \begin{matrix}J \\ i\end{matrix} ) ( \begin{matrix}J \\ n - i\end{matrix} )}{( \begin{matrix}N \\ n\end{matrix} )} [ {I}_{i > n - K} + {I}_{i < K} ] ] {λ}_{M} + {P}_{K} K {λ}_{N} . \qquad ( 13 )$$

The sum of indicator functions [I_{i>n-K}+I_{i<K}] in (13) is the number of sites with enough UP instances to cause an outage if the site fails.

### Unequal Combinations

The problem with the proposed solution in (13) is that the

$$( \begin{matrix}J \\ i\end{matrix} ) ( \begin{matrix}J \\ n - 1\end{matrix} ) / ( \begin{matrix}N \\ n\end{matrix} )$$

combinations are not all equally likely. It is true that if all sites are up, then all DN instances must be due to individual failures, thus all combinations are equally likely (and if n>(M−1)J, then all sites are up). And it is true that all combinations where every site has >0 UP instances are equally likely. However, combinations with 0 UP instances in a site could be due to J individual DN instances or 1 DN site. Hence, we need to break Pₙ apart and condition on m; that is, Pₙ=Σ_{m=┌n/J┐}^{M} P_{n|m}P_{M}(m).

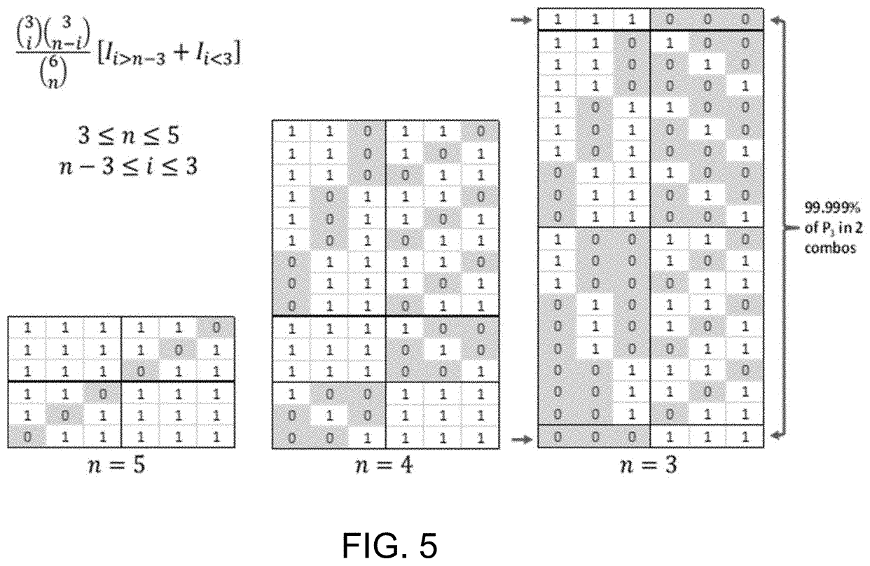

To illustrate, FIG. 5 shows the 41 feasible combinations for the small reference failure model of N=6, M=2, K=3. Transitions from n to DN are possible for 3≤n≤5. For each n, there are

$$( \begin{matrix}6 \\ n\end{matrix} )$$

distributions of n UP instances into 2 sites, and

$$( \begin{matrix}3 \\ i\end{matrix} ) ( \begin{matrix}3 \\ n - i\end{matrix} )$$

distributions of i UP instances to site 1 and n−i UP instances to site 2, where n−3≤i≤3.

As can be seen, for n=5 (left) there are 6 distributions of 5 UP instances to 2 sites (e.g., 3 with 2 in site 1 and 3 with 3 in site 1). Since both sites have UP instances, both sites are up. Since n=5>J=3, only site failures (not individual instance failures) can result in an outage. Since combinations are the result of a single instance failure, all combinations are equally likely. Finally, [I_{i>2}+I_{i<3}]=1 for all combinations.

For n=4 (center), there are 15 equally likely distributions of 4 UP instances (3 with 1 in site 1, 9 with 2 in site 1, and 3 with 3 in site 1). The main difference is that for the 9 combinations with 2 in site 1 (and 2 in site 2), [I_{i>1}+I_{i<3}]=2 (e.g., failure of either site results in an outage). For the remaining 6 combinations, [I_{i>1}+I_{i<3}]=1.

For n=3 (right), things get more interesting and the flaw in the ‘equally likely’ assumption is exposed. There are 20 distributions of 3 UP instances in 2 sites (1 with 0 in site 1, 9 with 1 in site 1, 9 with 2 in site 1, and 1 with 3 in site 1). The 18 combinations with 1 or 2 UP instances in site 1 (and vice versa in site 2) are the result of single instance failures, and all 18 combinations are equally likely. The 2 combinations with either 0 or 3 in site 1 (and vice versa in site 2) could result from 3 individual instance failures or 1 site failure, so these combinations are more likely. In fact, for the defaults in Table 1, these 2 combinations account for 99.999% of P₃.

To further illustrate, the erroneous “equally likely combinations” formula suggests

$${λ}_{D} = \{ {P}_{5} \frac{3 [ 1 ] + 3 [ 1 ]}{6} + {P}_{4} \frac{3 [ 1 ] + 9 [ 2 ] + 3 [ 1 ]}{15} + {P}_{3} \frac{1 [ 1 ] + 9 [ 2 ] + 9 [ 2 ] + 1 [ 1 ]}{20} \} {λ}_{M} + {P}_{3} 3 {λ}_{N} = \{ {P}_{5} [ 1. ] + {P}_{4} [ 1.6 ] + {P}_{3} [ 1.9 ] \} {λ}_{M} + {P}_{3} 3 {λ}_{N} . \qquad ( 14 )$$

For M=2, this scenario of unequal combinations can only happen when i=0 or n−i=0 (that is, when one site has no UP VMs). The result from the correct formula looks like

$${λ}_{D} = \{ \begin{matrix}{P}_{5} \frac{3 [ 1 ] + 3 [ 1 ]}{6} + {P}_{4} \frac{3 [ 1 ] + 9 [ 2 ] + 3 [ 1 ]}{15} \\ + {P}_{3 \vert 2} \frac{1 [ 1 ] + 9 [ 2 ] + 9 [ 2 ] + 1 [ 1 ]}{20} {P}_{M} ( 2 ) + {P}_{3 \vert 1} \frac{1 [ 1 ]}{1} {P}_{M} ( 1 )\end{matrix} \} {λ}_{M} + {P}_{3} 3 {λ}_{N} \qquad ( 15 )$$

$$= \{ {P}_{5} [ 1. ] + {P}_{4} [ 1.6 ] + {P}_{3 \vert 2} [ 1.9 ] {P}_{M} ( 2 ) + {p}_{3 \vert 1} [ 1. ] {P}_{M} ( 1 ) \} {λ}_{M} + {P}_{3} 3 {λ}_{N} .$$

### Outage Rate

As illustrated in this example, we can account for the fact that not all combinations are equally likely by breaking Pₙ apart and conditioning on m. The resulting exact formula for λ_{D} for general M is given by

$${λ}_{D} = {λ}_{M} {{\sum }_{n = K}}^{min ( K - 1 + J , N )} \{ {{\sum }_{m = ⌈ n / J ⌉}}^{M} {P}_{n \vert m} {ℱ}_{n , m} {P}_{M} ( m ) \} + {λ}_{N} {P}_{K} K . \qquad ( 16 )$$

$$For M = 1 , \\ {ℱ}_{n , m} = 1 and {λ}_{D} = {λ}_{M} {P}_{UP} + {λ}_{N} {P}_{K} K . \qquad ( 17 )$$

$$For M = 2 , \\ {ℱ}_{n , m} = {{\sum }_{i = max ( 0 , n - ( m - 1 ) J )}}^{min ( n , J )} [ \frac{( \begin{matrix}J \\ i\end{matrix} ) ( \begin{matrix}( m - 1 ) J \\ n - i\end{matrix} )}{( \begin{matrix}mJ \\ n\end{matrix} )} [ {I}_{i > n - K} + {I}_{n - i > n - K} ] ] . \qquad ( 18 )$$

$$For M = 3 , \\ {ℱ}_{n , m} = {{\sum }_{i = max ( 0 , n - ( m - 1 ) J )}}^{min ( n , J )} {{\sum }_{j = max ( 0 , n - ( m - 2 ) J - i )}}^{min ( n - i , J )} [ \text{} \frac{( \begin{matrix}J \\ i\end{matrix} ) ( \begin{matrix}J \\ j\end{matrix} ) ( \begin{matrix}( m - 2 ) J \\ n - i - j\end{matrix} )}{( \begin{matrix}mJ \\ n\end{matrix} )} * [ \text{} {I}_{i > n - K} + {I}_{j > n - K} + {I}_{i + j < K} ] ] . \qquad ( 19 )$$

$$For M = 4 , \\ {ℱ}_{n , m} = {{\sum }_{i = max ( 0 , n - ( m - 1 ) J )}}^{min ( n , J )} {{\sum }_{j = max ( 0 , n - ( m - 2 ) J - i )}}^{min ( n - i , J )} {{\sum }_{k = max ( 0 , n - ( m - 3 ) J - i - j )}}^{min ( n - i - j , J )} \\ [ \frac{( \begin{matrix}J \\ i\end{matrix} ) ( \begin{matrix}J \\ j\end{matrix} ) ( \begin{matrix}J \\ k\end{matrix} ) ( \begin{matrix}( m - 3 ) J \\ n - i - j - k\end{matrix} )}{( \begin{matrix}mJ \\ n\end{matrix} )} * [ \text{} {I}_{i > n - K} + {I}_{j > n - K} + {I}_{k > n - K} + {I}_{i + j + k < K} ] ] . \qquad ( 20 )$$

Although the equation for [symbol] becomes increasingly more awkward to express for increasing M, it is straightforward to program algorithmically for computation. Now that we have the exact formula for the mean time between service outages F=λ_{D}⁻¹, then also compute the mean time to restore service R=μ_{D}⁻¹=F(1−P_{UP})/P_{UP}. As shown below, these are tools to facilitate the analysis and optimal sizing of application topologies to meet service performance and reliability requirements.

### Example Application

As a hypothetical example, consider a Voice over IP (VoIP) call setup message processing application. The goal is to cost-effectively size the application (M sites and N virtual instances) to satisfy the following requirements and assumptions:

Application (service) availability≥0.99999.

Adequate capacity to process 600 VoIP calls/sec.

Peak traffic rate 1.5× average traffic rate.

Mean message processing latency≤30 ms, and 95th percentile (95%)≤60 ms.

Service outages lasting longer than 30 minutes are reportable.

Probability of a reportable outage in 1 year≤1%.

An outage occurs if available capacity<50% (2× over-engineering).

Local- and geo-redundancy required (minimum 2+ instances at each of 2+ sites).

Instances implemented as virtual machines (VMs) of the 4-vCPU flavor.

### Capacity and Latency Requirements

First, we consider the latency requirements to determine the required number of instances N. Given that voice call arrivals are reasonably random, and protocol message processing time is reasonably constant, assume an M/D/C service model, where C is the required number of vCPUs. Let E(W) and V(W) denote the mean and variance of the waiting time W prior to service. For simplicity, Kingman-K [symbol] llerst [symbol] rm heavy traffic GI/G/C two-moment approximations are used below for E(W) and V(W) based on the coefficients of variation Cₐ² and Cₛ² of the arrival process and the service process (where Cₐ²=1 and Cₛ²=0 for the MID/C system). Then the mean and variance of the waiting time W are given by

$$E ( W ) ≅ {T}^{0} ( \frac{ρ}{1 - ρ} ) [ \frac{{C}_{a}^{2} + {C}_{s}^{2}}{2} ] ) = {T}^{0} x , \qquad ( 21 )$$

$$and$$

$$V ( W ) ≅ {( {T}^{0} )}^{2} {C}_{s}^{2} + {( {T}^{0} )}^{2} \{ {{( \frac{ρ}{1 - ρ} )}^{2} [ \frac{{C}_{a}^{2} + {C}_{s}^{2}}{2} ]}^{2} [ 1 + \frac{4 ( 1 - ρ ) {C}_{s}^{2}}{ρ ( 1 + {C}_{s}^{2} )} ] \} = {( {T}^{0} x )}^{2} , \qquad ( 22 )$$

where T⁰ is the no-load message processing (code execution) time and

$$x = \frac{ρ}{2 ( 1 - ρ )} .$$

This Kingman-K [symbol] llerst [symbol] rm approximation assumes that W is exponentially distributed with mean T⁰x, and latency T=T⁰+W is a shifted exponential. The 95^{th} percentile latency is given approximately by T⁰+3E(W)=T⁰(1+3x). Thus, the performance requirements, combined with the capacity requirement of 600 calls/sec, become

$${T}^{0} \leq min \{ \frac{0.03}{1 + x} , \frac{0.06}{1 + 3 x} \} ,$$

where

$$x = \frac{ρ}{2 ( 1 - ρ )} , ρ = \frac{600 {T}^{0}}{C} ,$$

and C=number of vCPUs.

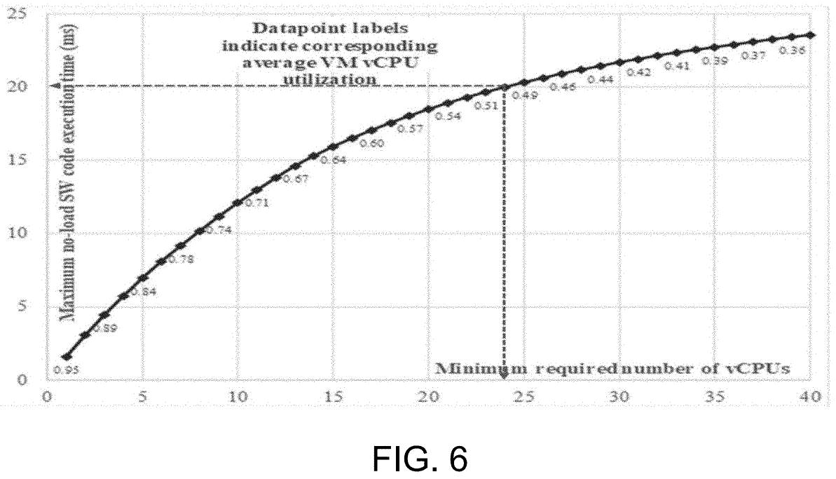

This result yields an explicit relationship between the maximum allowable processing time T⁰ and minimum required number of vCPUs C, as shown in FIG. 6. For ρ<⅔, the mean delay requirement is more constraining, while for ρ>⅔, the 95^{th} percentile requirement is more constraining. Since ρ≤50% is required to ensure adequate capacity in event of site failure, T⁰=20 ms and C=24. Finally, since SW instances are of the 4-vCPU flavor, N=6 instances are required (J=K=3). Note that this relationship places a requirement on the SW, and if the SW vendor cannot meet this 20 ms execution time target, then more vCPUs will be required.

### Reference Outage Model and Availability Requirement

Next, given the proposed minimum topology M=2, N=6, and J=K=3 that satisfies the latency requirements, we can now apply the reference outage model. For the default MTBF and MTTR values in Table 1, the model output parameters, explicit formulae, and resulting values are given in Table 2. As can be seen, based on the assumed MTBFs and MTTRs for this topology, F=323567 hours and R=67 minutes.

Now, consider the availability requirement and assume (worst case) that all outages occur during peak traffic periods, where the peak-to-average traffic ratio σ=1.5. Then

$$F \geq \frac{σ RA}{1 - A} = 166498 hours .$$

Since 323567>166498, the availability requirement is met, and it would appear that the minimum M=2, N=6 topology is sufficient. However, there should be verification that this solution meets the reportable outage requirement.

TABLE 2
Model parameters, explicit formulae, and resulting values
for N = 6, M = 2, K = 3.

| Parameter | Formula | Value | |
|---|---|---|---|
| P₆ | A_{M}²A_{N}⁶ | 9.9340E−01 | |
| P₅ | A_{M}²6A_{N}⁵(1 − A_{N}) | 5.4445E−03 | |
| P₄ | A_{M}²15A_{N}⁴(1 − A_{N})² | 1.2433E−05 | |
| P₃ | A_{M}²20A_{N}³(1 − A_{N})³ + 2A_{M}(1 − A_{M})A_{N}³ | 1.1373E−03 | |
| P₂ | A_{M}²15A_{N}²(1 − A_{N})⁴ + | 3.1166E−06 | |
| | 2A_{M}(1 − A_{M})3A_{N}²(1 − A_{N}) | | |
| P₁ | A_{M}²6A_{N}(1 − A_{N})⁵ + | 2.8468E−09 | |
| | 2A_{M}(1 − A_{M})3A_{N}(1 − A_{N})² | | |
| P₀ | A_{M}(1 − A_{N})⁶ + | 3.2550E−07 | |
| | 2A_{M}(1 − A_{M})(1 − A_{N})³ + (1 − A_{M})² | | |
| P_{UP} | P₆ + P₅ + P₄ + P₃ | 0.99999656 | |
| P_{DN} | P₂ + P₁ + P₀ | 0.00000344 | |
| F | [P₅1.0λ_{M} + P₄1.6λ_{M} + P₃1.9λ_{M} + P₃3λ_{N}]⁻¹ | 323567 | hr |
| R | FP_{DN}/P_{UP} | 1.11 | hr |

### Reportable Outage Requirement

Next, consider the service outage requirement P(no outages>30m in 1 year)≥99%.

$$P ( no outages > 0.5 hours in 8760 hours ) \qquad ( 23 )$$

$$= {{\sum }_{n = 0}}^{∞} P ( no outages > 0.5 hours \vert n outages ) P ( n outages in 8760 hours ) \\ \\$$

$$= {{\sum }_{n = 0}}^{∞} {[ 1 - {e}^{- \frac{μ}{2}} ]}^{n} \frac{{( 8760 λ )}^{n} {e}^{- 8760 λ}}{n !} = {e}^{- 8760 λ} {{\sum }_{n = 0}}^{∞} \frac{{( 8760 λ [ 1 - {e}^{- \frac{μ}{2}} ] )}^{n}}{n !}$$

$$= {e}^{- 8760 λ} {e}^{8760 λ} [ 1 - {e}^{- μ / 2} ] = {e}^{- 8760 λ {e}^{- μ / 2}} \geq 99 \% .$$

Then λe^{-μ/2}≤−ln(0.99)/8760=871613⁻¹ and F≥871613e^{-0.5/1.11}=556564 hours. Since 323567<556564, the reportable outage requirement is not met.

In view of the above, there are a number of options, that can be evaluated using the reference outage model. First, we can model the effect of hardening the HW or SW elements by increasing their MTBFs or decreasing their MTTRs. The details are omitted, but hardening the instance SW (increasing λ₁⁻¹ from 3 to 13 months) or the resident function SW (increasing λ_{F}⁻¹ from 2 to 6.4 years) both result in increasing F above 556564 hours. Interestingly, decreasing the SW MTTRs is not as effective because in this particular example (where the reportable service outage requirement is most constraining), the solution is more sensitive to failure rates than to restoral rates. Notably, hardening the HW (increasing MTBFs or decreasing MTTRs) does not help, lending analytical support to the trend of using commodity hosts and public cloud sites instead of high-end servers and hardened Telco datacenters.

Next, instances (increase N) can be added or sites (increase M). Adding a fourth host/instance to each site (M=2, N=8, J=4) meets the requirement. Also, adding a third site and redistributing the hosts/instances (M=3, N=6, J=2) also meets the requirement. The reason is that although site failures are now more frequent with three sites, so a {2 site} duplex failure is now more likely, the much more probable {1 site+1 instance} duplex failure is no longer an outage mode.

### Topology Configuration Tool

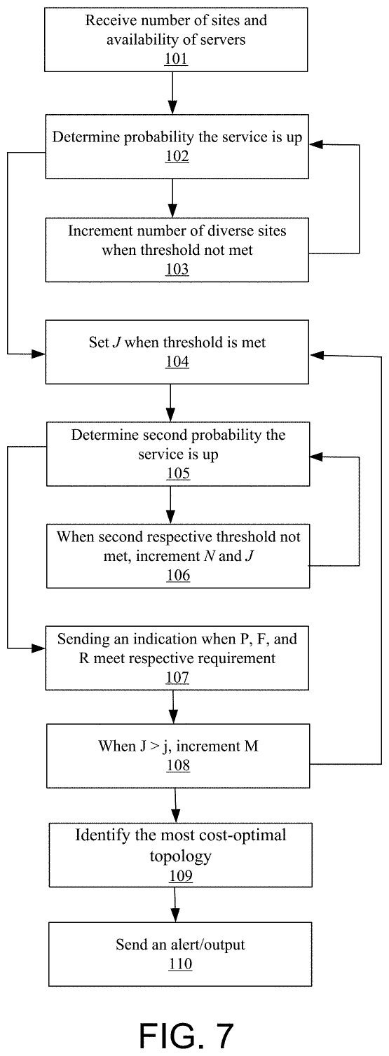

FIG. 7 illustrates an exemplary method for reliability reference model for topology configuration. Given the minimal topology description of M sites, N hosts, J=N/M instances/site, and K instances required for service to be up, and given the basic failure and restoral rates {λ_{I}, λ_{F}, λ_{H}, λ_{S}} and {μ_{I}, μ_{F}, μ_{H}, μ_{S}} of the {instance SW, function SW, host HW, site HW}, there is a determination of the exact formulae for the service availability A=P_{UP}, the mean time between service outages F=λ_{D}⁻¹, and the mean time to restore service R=μ_{D}⁻¹. This reference outage model forms a topology configuration and optimization tool. Instead of inputting M, N, and K, and computing A and F, there is an input of requirements for availability A and capacity K (and possibly other metrics), and then compute the most cost-effective system topology M and N.

Consider the following topology configuration and optimization algorithm.

TABLE 3
Inputs

MTBFs and MTTRs for {instance, function, host, site}
Annualized capital and operational expense costs {C_{M}, O_{M}, C_{N}, O_{N}}
Required availability A and capacity K
Required local- and geo-redundancy J ≥ j ≥ 1 and M ≥ m ≥ 1
Required mean outage and restoral times F ≥ f and R ≤ r, etc.

There may be an objective function to minimize {(C_{M}+O_{M})M+(C_{N}+O_{N})N} subject to P_{UP}≥A, J≥j, M≥m, F≥f, R≤r, etc. Given the inputs, the approach is to compute a family of feasible solution pairs {M,N} that are generally in the range {m,Nₘₐₓ}, . . . , (Mₘₐₓ,j}. The most cost-optimal topology is then easily determined given the capital and operational expense costs.

At step 101, receive, by a server or other device, the number of geographically diverse sites (M) for the service and the availability of the service (A_{N}). For example, setting M=m and A_{N}=1 (i.e., only site failures can occur).

At step 102, determine the probability the service is up (P_{UP}), mean time between service outages (F), and mean restoral time (R) based on the information of step 101. Solve for a first {P_{UP}, F, R}.

At step 103, when the output {P_{UP}, F, R} do not meet their respective requirements (that is, no feasible solution exists for M for any N), then increment M←M+1 and repeat step 102, solving for successive {P_{UP}, F, R} values.

At step 104, when the output {P_{UP}, F, R} meets their respective requirements, set J=max(┌K/M┐, j), N=MJ, and A_{N}=μ_{N}/(λ_{N}+μ_{N}).

At step 105, based on the information of step 104, determine the probability the service is up (P_{UP}), mean time between service outages (F), and mean restoral time (R). Solve for a new {P_{UP}, F, R}.

At step 106, when an output of {P_{UP}, F, R} do not meet their respective requirements, then increment N←N+M and J←J+1, and repeat step 105, solving for successive {P_{UP}, F, R} values.

At step 107, sending an indication that {M, N} as a feasible solution, when the output of {P_{UP}, F, R} meets their respective requirements.

At step 108, when J>j, then increment M←M+1 and go to step 104; otherwise, stop.

At step 109, based on the output of steps 104 through 108, the set of feasible solution pairs {M,N} that are generally in the range {m,Nₘₐₓ}, . . . , (Mₘₐₓ,j} have been identified. The objective function {(C_{M}+O_{M})M+(C_{N}+O_{N})N} is now computed for each feasible solution pair {M,N} collected at step 109, and the {M,N} pair that minimizes the objective function is identified as the most cost-optimal topology.

At step 110, output of step 109 (or any of the above steps) may be sent within an alert, which may be displayed on a device or used as a trigger. The alert may trigger the search for the M candidate physical sites in which to place the application, and the ordering of physical hardware (N servers and possibly racks, switches, routers, links, etc.) to be placed in those sites.

A 2-tiered reference model is used that consists of servers and sites to illustrate an approach to topology configuration and optimization, with a focus on addressing geo-redundancy questions like how many sites, and how many servers per site, are required to meet performance and reliability requirements. First develop a multi-dimensional component failure mode reference model, then exactly reduce this model to a one-dimensional service outage mode reference model. A contribution is the exact derivation of the outage and restoral rates from the set of ‘available’ states to the set of ‘unavailable’ states using an adaptation of the hyper-geometric “balls in urns” distribution with unequally likely combinations. A topology configuration tool for optimizing resources to meet requirements and illustrate effective use of the tool for a hypothetical VoIP call setup protocol message processing application is described.

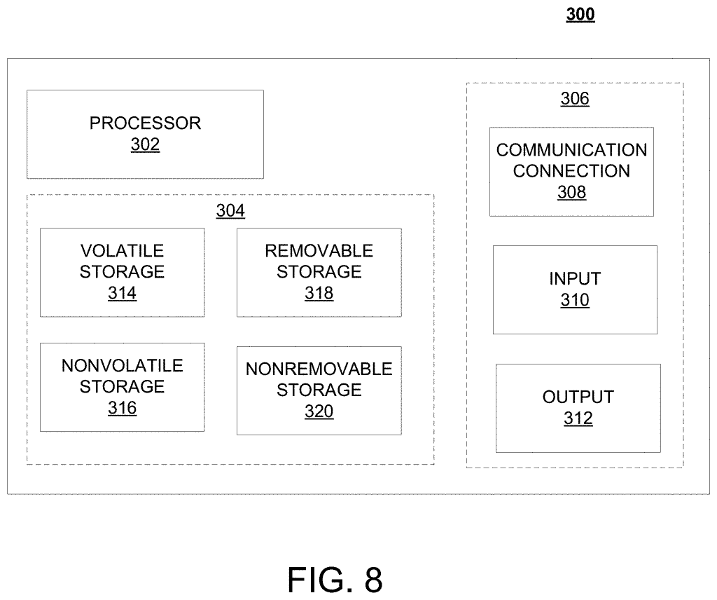

FIG. 8 is a block diagram of network device 300 that may be connected to or comprise a component of a network. Network device 300 may comprise hardware or a combination of hardware and software. The functionality to facilitate telecommunications via a telecommunications network may reside in one or combination of network devices 300. Network device 300 depicted in FIG. 8 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 8 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 8) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

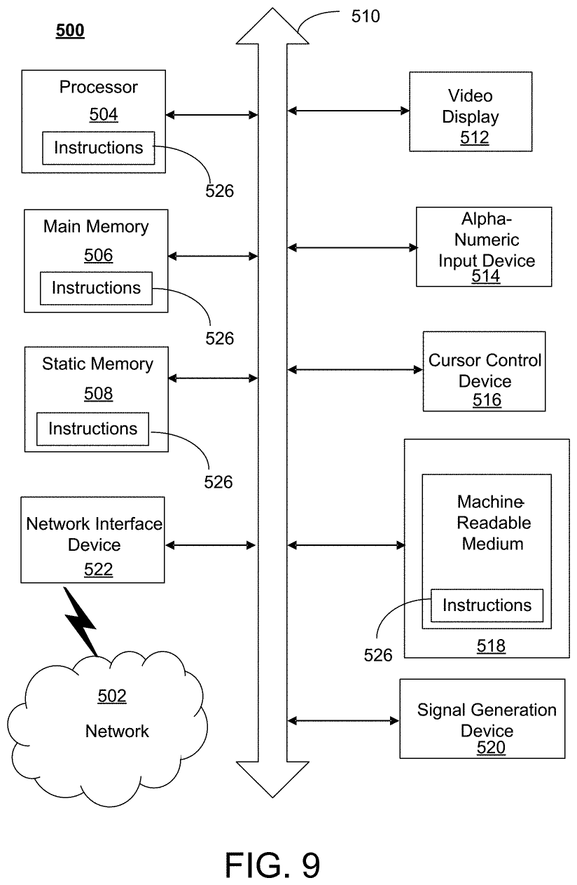

FIG. 9 depicts an exemplary diagrammatic representation of a machine in the form of a computer system 500 within which a set of instructions, when executed, may cause the machine to perform any one or more of the methods described above. One or more instances of the machine can operate, for example, as processor 302. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a system in which reliability reference model for topology configuration alerts can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—reliability reference model for topology configuration—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for receiving a number of geographically diverse sites for a service; receiving a minimum availability of the service; based on the number of geographically diverse sites and the minimum availability, determining a probability that the service is up (P_{UP}), mean time between service outages (F), and mean restoral time (R); and sending an alert that includes the P_{UP}, F, and R. F may be determined by:

$${F}^{- 1} = {λ}_{D} = {λ}_{M} {\sum }_{n = K}^{min ( K - 1 + J , N )} \{ {\sum }_{m = ⌈ n / J ⌉}^{M} {P}_{n \vert m} {ℱ}_{n , m} {P}_{M} ( m ) \} + {λ}_{N} {P}_{K} K ,$$

where λ_{D} is the mean service outage rate, λ_{M} is the site failure rate, λ_{N} is the host failure rate, K is the minimum required capacity, J=N/M is the number of hosts per site, P_{n|m} is the probability of n hosts up given m sites up, P_{M}(m) is the probability of m sites up, P_{K} is the probability of K hosts up, and [symbol] is the number of sites out of the m sites up that have more than n−K hosts up. P_{n|m}, P_{M}(m), and P_{K} are determined by the solution to the Markov chain model arising from the problem formulation, and [symbol] is determined by the solution to a specialized “balls in urns” model involving the hyper-geometric distribution with unequally likely combinations. All combinations in this paragraph the below paragraph (including the removal or addition of steps) are contemplated in a manner that is consistent with the other portions of the detailed description

The methods, systems, and apparatuses may provide for when PUP, F, and R do not meet a respective threshold requirement, incrementing the number of geographically diverse sites for the service; and based on the incremented number of geographically diverse sites, determining a second PUP, second F, and second R. The methods, systems, and apparatuses may provide for when PUP, F, and R meet a respective threshold requirement, setting J=max(┌K/M┐, j), N=MJ, and A_{N}=μ_{N}/(λ_{N}+μ_{N}). Additionally, A_{N} is the probability that all N hosts are up, and μ_{N} is the host restoral rate. The methods, systems, and apparatuses may provide for based on J=max(┌K/M┐, j), N=MJ, and A_{N}=μ_{N}/(λ_{N}+μ_{N}), determining a third P_{UP}, third F, and third R. The methods, systems, and apparatuses may provide for when third P_{UP}, third F, and third R do not meet a second respective threshold requirement, incrementing N by M and J by 1 (that is, replace N with N+M and J with J+1). All combinations in this paragraph (including the removal or addition of steps) are contemplated in a manner that is consistent with the other portions of the detailed description.

What is claimed:

1. A method comprising:
receiving a number of geographically diverse sites M and a number of hosts N for a service;
receiving a minimum availability and capacity of the service;
based on the number of geographically diverse sites and hosts and the minimum availability and capacity, determining a probability that the service is up (P_{UP}), mean time between service outages (F), and mean restoral time (R); and
sending an alert that includes the P_{UP}, F, and R.

2. The method of claim 1, further comprising when P_{UP}, F, and R do not meet a respective threshold requirement, incrementing the number of geographically diverse sites for the service.

3. The method of claim 1, further comprising:
when P_{UP}, F, and R do not meet a respective threshold requirement, incrementing the number of geographically diverse sites for the service; and
based on the incremented number of geographically diverse sites, determining a second P_{UP}, second F, and second R.

4. The method of claim 1, further comprising when P_{UP}, F, and R meet a respective threshold requirement, setting J=max(┌K/M┐, j), N=MJ, and A_{N}=μN/(λ_{N}+μ_{N}),
where additionally A_{N} is the probability that all N hosts are up, and μ_{N} is the host restoral rate.

5. The method of claim 1, further comprising:
when P_{UP}, F, and R meet a respective threshold requirement, setting J=max(┌K/M┐, j), N=MJ, and A_{N}=μ_{N}(λ_{N}+μ_{N}), and
based on J=max(┌K/M┐, j), N=MJ, and A_{N}=μ_{N}/(λ_{N}+μ_{N}), determining a third P_{UP}, third F, and third R.

6. The method of claim 1, further comprising:
when P_{UP}, F, and R meet a respective threshold requirement, setting J=max(┌K/M┐, j), N=MJ, or A_{N}=μ_{N}/(λ_{N}+μ_{N}),
based on J=max(┌K/M┐, j), N=MJ, or A_{N}=μ_{N}/(λ_{N}+μ_{N}), determining a third P_{UP}, third F, and third R; and
when third P_{UP}, third F, and third R do not meet a second respective threshold requirement, incrementing N by M and J by 1.

7. The method of claim 1, wherein F is determined by:
$${F}^{- 1} = {λ}_{D} = {λ}_{M} {\sum }_{n = K}^{min ( K - 1 + J , N )} \{ {\sum }_{m = ⌈ n / J ⌉}^{M} {P}_{n \vert m} {ℱ}_{n , m} {P}_{M} ( m ) \} + {λ}_{N} {P}_{K} K ,$$
where λ_{D} is the mean service outage rate, λ_{M} is the site failure rate, λ_{N} is the host failure rate, K is the minimum required capacity, J=N/M is the number of hosts per site, P_{n|m} is the probability of n hosts up given m sites up, P_{M} (m) is the probability of m sites up, P_{K} is the probability of K hosts up, and [symbol] is the number of sites out of the m sites up that have more than n−K hosts up. P_{n|m}, P_{M} (m), and P_{K} are determined by the solution to the Markov chain model arising from the problem formulation, and [symbol] is determined by the solution to a “balls in urns” model involving the hyper-geometric distribution with unequally likely combinations.

8. A system comprising:
one or more processors; and
memory coupled with the one or more processors, the memory storing executable instructions that when executed by the one or more processors cause the one or more processors to effectuate operations comprising:
receiving a number of geographically diverse sites M and a number of hosts N for a service;
receiving a minimum availability and capacity of the service;
based on the number of geographically diverse sites and hosts and the minimum availability and capacity, determining a probability that the service is up (P_{UP}), mean time between service outages (F), and mean restoral time (R); and
sending an alert that includes the P_{UP}, F, and R.

9. The system of claim 8, the operations further comprising when P_{UP}, F, and R do not meet a respective threshold requirement, incrementing the number of geographically diverse sites for the service.

10. The system of claim 8, the operations further comprising:
when P_{UP}, F, and R do not meet a respective threshold requirement, incrementing the number of geographically diverse sites for the service; and
based on the incremented number of geographically diverse sites, determining a second P_{UP}, second F, and second R.

11. The system of claim 8, the operations further comprising when P_{UP}, F, and R meet a respective threshold requirement, setting J=max(┌K/M┐, j), N=MJ, and A_{N}=μ_{N}/(λ_{N}+μ_{N}), where additionally A_{N} is the probability that all N hosts are up, and μ_{N} is the host restoral rate.

12. The system of claim 8, the operations further comprising:
when P_{UP}, F, and R meet a respective threshold requirement, setting J=max(┌K/M┐, j), N=MJ, and A_{N}=μ_{N}/(λ_{N}+μ_{N}); and
based on J=max(┌K/M┐, j), N=MJ, and A_{N}=μ_{N}/(λ_{N}+μ_{N}), determining a third P_{UP}, third F, and third R.

13. The system of claim 8, the operations further comprising:
when P_{UP}, F, and R meet a respective threshold requirement, setting J=max(┌K/M┐, j), N=MJ, or A_{N}=μ_{N}/(λ_{N}+μ_{N});
based on J=max(┌K/M┐, j), N=MJ, or A_{N}=μ_{N}/(λ_{N}+μ_{N}), determining a third P_{UP}, third F, and third R; and
when third P_{UP}, third F, and third R do not meet a second respective threshold requirement, incrementing N by M and J by 1.

14. The system of claim 8, wherein F is determined by:
$${F}^{- 1} = {λ}_{D} = {λ}_{M} {\sum }_{n = K}^{min ( K - 1 + J , N )} \{ {\sum }_{m = ⌈ n / J ⌉}^{M} {P}_{n \vert m} {ℱ}_{n , m} {P}_{M} ( m ) \} + {λ}_{N} {P}_{K} K ,$$
where λ_{D} is the mean service outage rate, λ_{M} is the site failure rate, λ_{N} is the host failure rate, K is the minimum required capacity, J=N/M is the number of hosts per site, P_{n|m} is the probability of n hosts up given m sites up, P_{M}(m) is the probability of m sites up, P_{K} is the probability of K hosts up, and [symbol] is the number of sites out of the m sites up that have more than n−K hosts up. P_{n|m}, P_{M}(m), and P_{K} are determined by the solution to the Markov chain model arising from the problem formulation, and [symbol] is determined by the solution to a “balls in urns” model involving the hyper-geometric distribution with unequally likely combinations.

15. A computer readable storage medium storing computer executable instructions that when executed by a computing device cause said computing device to effectuate operations comprising:
receiving a number of geographically diverse sites M and a number of hosts N for a service;
receiving a minimum availability and capacity of the service;
based on the number of geographically diverse sites and hosts and the minimum availability and capacity, determining a probability that the service is up (P_{UP}), mean time between service outages (F), and mean restoral time (R); and
sending an alert that includes the P_{UP}, F, and R.

16. The computer readable storage medium of claim 15, the operations further comprising:
when P_{UP}, F, and R do not meet a respective threshold requirement, incrementing the number of geographically diverse sites for the service; and
based on the incremented number of geographically diverse sites, determining a second P_{UP}, second F, and second R.

17. The computer readable storage medium of claim 15, the operations further comprising when P_{UP}, F, and R meet a respective threshold requirement, setting J=max(┌K/M┐, j), N=MJ, and A_{N}=μ_{N}/(λ_{N}+μ_{N}),
where additionally A_{N} is the probability that all N hosts are up, and μ_{N} is the host restoral rate.

18. The computer readable storage medium of claim 15, the operations further comprising:
when P_{UP}, F, and R meet a respective threshold requirement, setting J=max(┌K/M┐, j), N=MJ, and A_{N}=μ_{N}/(λ_{N}+μ_{N}); and
based on J=max(┌K/M┐, j), N=MJ, and A_{N}=μ_{N}/(λ_{N}+μ_{N}), determining a third P_{UP}, third F, and third R.

19. The computer readable storage medium of claim 15, the operations further comprising:
when P_{UP}, F, and R meet a respective threshold requirement, setting J=max(┌K/M┐, j), N=MJ, or A_{N}=μ_{N}/(λ_{N}+μ_{N});
based on J=max(┌K/M┐, j), N=MJ, or A_{N}=μ_{N}/(λ_{N}+μ_{N}), determining a third P_{UP}, third F, and third R; and
when third P_{UP}, third F, and third R do not meet a second respective threshold requirement, incrementing N by M and J by 1.

20. The computer readable storage medium of claim 15, wherein F is determined by:
$${F}^{- 1} = {λ}_{D} = {λ}_{M} {\sum }_{n = K}^{min ( K - 1 + J , N )} \{ {\sum }_{m = ⌈ n / J ⌉}^{M} {P}_{n \vert m} {ℱ}_{n , m} {P}_{M} ( m ) \} + {λ}_{N} {P}_{K} K ,$$
where λ_{D} is the mean service outage rate, λ_{M} is the site failure rate, λ_{N} is the host failure rate, K is the minimum required capacity, J=N/M is the number of hosts per site, P_{n|m} is the probability of n hosts up given m sites up, P_{M}(m) is the probability of m sites up, P_{K} is the probability of K hosts up, and [symbol] is the number of sites out of the m sites up that have more than n−K hosts up. P_{n|m}, P_{M}(m), and P_{K} are determined by the solution to the Markov chain model arising from the problem formulation, and [symbol] is determined by the solution to a “balls in urns” model involving the hyper-geometric distribution with unequally likely combinations.
